(19) United States
(12) Patent Application Publication
(10) Pub. No.: US 2013/0101063 A1
(43) Pub. Date: Apr. 25, 2013

(54) DFT-BASED CHANNEL ESTIMATION SYSTEMS AND METHODS

(71) Applicant: NEC Laboratories America, Inc., Princeton, NJ (US)

(72) Inventors: Meilong Jiang, Plainsboro, NJ (US); Guosen Yue, Plainsboro, NJ (US); Narayan Prasad, Wyncote, PA (US); Sampath Rangarajan, Bridgewater, NJ (US)

(73) Assignee: NEC LABORATORIES AMERICA, INC., Princeton, NJ (US)

(21) Appl. No.: 13/655,073

(22) Filed: Oct. 18, 2012

Related U.S. Application Data
(60) Provisional application No. 61/548,866, filed on Oct. 19, 2011.

(51) Int. Cl. H04B 15/00

(52) U.S. Cl. 375/285

(57) ABSTRACT

DFT-based channel estimation methods and systems are disclosed. One system includes an inverse discrete Fourier transform module, a noise power estimator, a noise filter and a discrete Fourier transform module. The inverse discrete Fourier transform module is configured to determine time domain estimates by applying an inverse discrete Fourier transform to initial channel estimates computed from pilot signals. Additionally, the noise power estimator is configured to estimate noise power by determining and utilizing time domain samples that are within a vicinity of sinc nulls of the time domain estimates. The noise filter is configured to filter noise from the time domain estimates based on the estimated noise power to obtain noise filtered time domain estimates. Further, the discrete Fourier transform module is configured to perform a discrete Fourier transform on the noise filtered time domain estimates to obtain frequency domain channel estimates for channels on which pilot signals are transmitted.

### RELATED APPLICATION INFORMATION

This application claims priority to provisional application Ser. No. 61/548,866 filed on Oct. 19, 2011, incorporated herein by reference.

### BACKGROUND

1. Technical Field

The present invention relates to channel estimation and, more particularly, to discrete Fourier transform-based channel estimation.

2. Description of the Related Art

In orthogonal frequency-division multiplexing (OFDM)-based wireless systems, such as Long Term Evolution (LTE), two types of frequency domain channel estimation techniques have been widely studied: linear minimum mean square (LMMSE) and least square (LS). LMMSE channel estimation (CE) has a better performance at the cost of significant complexity involving large matrix inversion and its requiring a priori knowledge of second order channel statistics and the operating signal to noise ratio (SNR). Thus, it is not suitable for most practical implementations. LS CE has low complexity but it suffers performance degradation, especially at low SNR, due to the neglect of noise effects.

DFT-based channel estimation schemes, also referred as transform domain (TD) CE techniques, de-noise the LS estimates in the transform domain (time domain) to improve LS CE performance. Existing DFT-based CE schemes inherit low complexity merit from LS but suffer significant performance degredation due to the channel impulse response (CIR) energy leakage, especially when relatively small resource blocks (RBs) are allocated. Such small resource block (RB) allocation is quite common in the case of an LTE uplink.

In one DFT-based channel estimation scheme, a low pass filter with a cut-off frequency set as a cyclic prefix (CP) length is applied in the transform domain to keep the useful channel impulse response (CIR) signals in the low frequency region ('energy concentration') and to suppress the noise outside the “energy concentration” region by setting the corresponding samples to zeros. This is based on the fact that, in OFDM systems, the symbol length is much longer than the maximum channel delay taps. In other schemes, the noise within the “energy concentration” region is further suppressed by removing the insignificant channel coefficients whose amplitudes are smaller than a threshold determined by average noise power. Therefore, a properly designed threshold is decisive for the noise suppression and final estimation performance. In other schemes, the noise power is estimated by averaging the transform domain samples with insignificant channel coefficients located at a “noise-only” region (complementary to the ‘energy concentration’ region).

### SUMMARY

One embodiment of the present principles is directed to a method for performing channel estimation. In accordance with the method, time domain estimates are determined by applying an inverse discrete Fourier transform to initial channel estimates computed from pilot signals. In addition, noise power is estimated by selecting and averaging powers of time domain samples that are within a vicinity of sinc null points of the time domain estimates. Further, noise is filtered from the time domain estimates based on the estimated noise power to obtain noise filtered time domain estimates. A discrete Fourier transform is applied on the noise filtered time domain estimates to obtain frequency domain channel estimates for channels on which the pilot signals are transmitted.

An alternative embodiment is also directed to a method for performing channel estimation. Here, time domain estimates are determined by applying an inverse discrete Fourier transform to initial channel estimates computed from pilot signals. In addition, noise power is estimated by accumulating powers of a plurality of time domain samples in a plurality of windows that are within a vicinity of sinc null points of the time domain estimates. Further, noise is filtered from the time domain estimates based on the estimated noise power to obtain noise filtered time domain estimates. A discrete Fourier transform is applied to the noise filtered time domain estimates to obtain frequency domain channel estimates for channels on which the pilot signals are transmitted.

Another embodiment is directed to a system for performing channel estimation. The system includes an inverse discrete Fourier transform module, a noise power estimator, a noise filter and a discrete Fourier transform module. The inverse discrete Fourier transform module is configured to determine time domain estimates by applying an inverse Fourier transform to initial channel estimates computed from pilot signals. In addition, the noise power estimator is configured to estimate noise power by determining and utilizing time domain samples that are within a vicinity of sinc null points of the time domain estimates. The noise filter is configured to filter noise from the time domain estimates based on the estimated noise power to obtain noise filtered time domain estimates. Further, the discrete Fourier transform module is configured to perform a discrete Fourier transform on the noise filtered time domain estimates to obtain frequency domain channel estimates for channels on which the pilot signals are transmitted.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a prior art DFT-based channel estimation system/method;

FIG. 2 is a block/flow diagram of a channel estimation system/method that employs a sinc-null based power estimation scheme in accordance with an exemplary embodiment of the present principles;

FIG. 3 is a block/flow diagram of a channel estimation system/method that employs a moving window sinc-null based power estimation scheme in accordance with an exemplary embodiment of the present principles;

FIG. 4 is a block/flow diagram of a channel estimation system/method that employs a basic sinc-null based power estimation scheme and a moving window sinc-null based power estimation scheme in accordance with an exemplary embodiment of the present principles; and

FIG. 5 is a flow diagram of an exemplary channel estimation method in accordance with an exemplary embodiment of the present principles.

### DETAILED DESCRIPTION OF PREFERRED EMBODIMENTS

As indicated above, there are at least two drawbacks of existing DFT-based CE schemes. Firstly, there is performance degradation due to a hard cut-off window in the low pass filter that ignores CIR energy leaked into the “noise only” region, especially for small RB allocation. This will result in a severe MSE error floor. The second drawback is due to the inaccurate noise power estimation that leads to removal of useful CIR samples within the low pass filter region. This results in further MSE performance loss. One known system employs a method that estimates in-band noise variance and uses it for an approximated MMSE CE. However, this method has a relatively high complexity and its performance is susceptible to timing offsets.

Enhanced DFT-based channel estimation methods and systems in accordance with the present principles can overcome the above-mentioned drawbacks in existing DFT-based channel estimation schemes while maintaining the advantage of low-complexity implementation. In accordance with one exemplary aspect, noise power can be estimated by averaging over the CIR samples in the vicinity of sinc function nulls, which carry the least interference from useful CIR signals. Thus, the noise estimation is immune to CIR energy leakage and provides accurate results. Further, a dynamic noise filter windowing that is based on the optimally estimated noise power can be applied. In contrast to systems that utilize a low pass filter, the filtering described herein suppresses the noise in the transform domain while taking into account useful signals that would otherwise be discarded by a low pass filter. This exemplary method has a low complexity and exhibits a relatively low mean square error (MSE) and block error rate (BLER). In addition, in accordance with another aspect, noise estimation can be performed by employing moving windows to address the presence of timing offsets.

It should be understood that embodiments described herein may be entirely hardware or may include both hardware and software elements, which includes but is not limited to firmware, resident software, microcode, etc. In a preferred embodiment, the present invention is implemented in hardware.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Prior to describing exemplary embodiments of the present principles in detail, for expository purposes, some general aspects of transmission schemes in which the present principles can be implemented will be described. In the LTE uplink, demodulation reference symbols (DMRS) are transmitted as a pilot signal to perform channel estimation for coherent demodulation of uplink data and/or control signaling The DMRS is sent at the fourth and eleventh OFDM symbols in each transmit time interval (TTI) (consisting of two slots with seven OFDM symbols in each slot for a normal CP) and it occupies the same RB resources as those allocated for data transmission of each user-equipment device (UE). The user-equipment devices (UEs) are orthogonally separated in the frequency domain in accordance with the single carrier frequency domain multiple access (SC-FDMA) scheme to enable the performance of channel estimation independently for each UE. Unlike the data signal, the reference signal will not pass through the DFT spread block.

At eNodeB, the received signal over a multipath fading channel in a symbol interval that can be expressed as

$$y ( n ) = {\sum }_{l = 0}^{L - 1} h ( n , l ) x ( n - l ) + w ( n ) , n = 0 , 1 , … , N - 1. \qquad ( 1 )$$

where n denotes the time domain sample index and l denotes the channel taps index. L denotes the channel length and w(n) denotes the independently and identically distributed (i.i.d) additive white Gaussian noise (AWGN) in the time domain with zero mean and variance σ_{w}².

Providing that CP length N_{c} is longer than CIR length L, the frequency domain received signal of the DMRS sequence at subcarrier k is given by

Y(k)=H(k)C(k)+W(k) (2)

where C(k) is the k th sample taken from a Zadoff-Chu sequence with unit power E[|C(k)|²]=1 and a perfect auto-correlation property. H(k) is the channel frequency response (CFR) at the k th tone. W(k) is the additive noise in the frequency domain.

A low complexity channel estimation based on LS criteria can be obtained for each DMRS sub-carrier as follows

$${\hat{H}}_{LS} ( k ) = \frac{Y ( k )}{C ( k )} + \frac{W ( k )}{C ( k )} . \qquad ( 3 )$$

The LS CE results in an unacceptable MSE especially at a low SNR region. DFT-based CE schemes have been widely studied to address the noise degradation in LS CE.

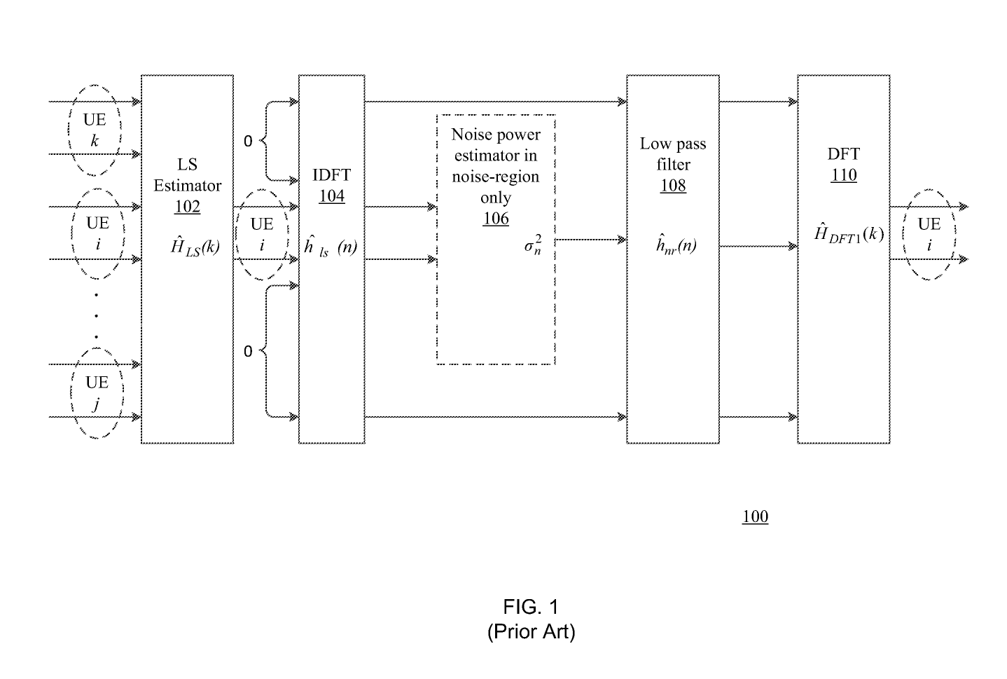

For example, referring now to the drawings in which like numerals represent the same or similar elements and initially to FIG. 1, for comparison purposes, a prior art channel estimation system/method 100 is illustratively depicted. This conventional DFT-based channel estimation exploits the fact that OFDM systems have a symbol length that is much longer than the length of the CIR. It is noted that the user equipment devices (UEs) are orthogonally allocated in the LTE uplink and each UE will perform the DFT-based CE independently.

The system/method 100 can be initiated at block 102, in which a low complexity least square (LS) channel estimation, as described above, is performed for each subcarrier k in the frequency domain.

At block 104, for each UE, the LS estimates are first extended to a size-N block by padding zeros at the unallocated tones, i.e.

$${\hat{H}}_{ext} ( k ) = \{ \begin{matrix}{\hat{H}}_{LS} ( k ) , & k ∈ S , \\ 0 , & k ⊈ S , 0 \leq k \leq N - 1\end{matrix} \qquad ( 4 )$$

where S denotes the contiguous trunk of sub-carriers allocated to a UE. The extended block is then transformed to the time domain via a size-N Inverse Discrete Fourier Transform (IDFT) to obtain the transform domain or time domain estimates ĥ_{LS}(n).

$${\hat{h}}_{LS} ( n ) = \frac{1}{N} {\sum }_{k = 0}^{N - 1} {\hat{H}}_{ext} ( k ) {e}^{j 2 π \frac{nk}{N}} , 0 \leq n \leq N - 1 \qquad ( 5 )$$

At block 108 (and optionally block 106, discussed in more detail herein below), a low pass de-noise filter is then applied in the time domain to suppress/reduce noise. For example, in one implementation, a low pass filter without in-band noise removal can be employed at block 108. Here, the low pass filtering w_{LPF}(n) can be designed by simply keeping the transform domain samples at low frequency as useful CIR samples and setting the samples at high frequency to be zeros, i.e.,

$${w}_{LPF} ( n ) = \{ \begin{matrix}1 , & 0 \leq n \leq {f}_{c} - 1 , N - {f}_{c} \leq n \leq N - 1 \\ 0 , & otherwise\end{matrix} \qquad ( 6 )$$

where f_{c} is the “cut-off” frequency of the transform domain filter. Note that N−2f_{c} samples have been removed by this hard cut-off boundary, which might contain useful CIR information smearing into the high frequency. f_{c} is commonly chosen as channel length L or CP length N_{c} if there is no knowledge about channel length L. Thus, the transform domain estimates after noise-removing are given by

ĥₙᵣ(n)=w_{LPF}(n)ĥ_{LS}(n), 0≦n≦N−1 (7)

At block 110, the time domain filtered/noise suppressed samples are transformed via DFT to obtain the final channel estimates back in the frequency domain of the allocated subcarriers for each UE.

$${\hat{H}}_{dft} ( k ) = {\sum }_{k = 0}^{N - 1} {\hat{h}}_{nr} ( n ) {e}^{- j 2 π \frac{nk}{N}} , 0 \leq k \leq N - 1 \qquad ( 8 )$$

The low pass filter block 108 described above leads to an MSE floor due to CIR energy leakage, especially at low RB allocation. One additional improvement that can be implemented at block 108 is to further suppress the noise effect in the low pass filter region by comparing LS estimates power with a threshold determined by the estimated noise power. Thus, the noise removal filter can be further updated as (9):

$${w}_{LPFNR} ( n ) = \{ \begin{matrix}1 , & {\vert {h}_{LS} ( n ) \vert}^{2} \geq α {σ}_{n}^{2} , 0 \leq n \leq {N}_{c} - 1 , N - {N}_{c} \leq n \leq N - 1 \\ 0 , & {\vert {h}_{LS} ( n ) \vert}^{2} < α {σ}_{n}^{2} , 0 \leq n \leq {N}_{c} - 1 , N - {N}_{c} \leq n \leq N - 1 \\ 0 , & {N}_{c} \leq n < N - {N}_{c}\end{matrix} \qquad ( 9 )$$

In (9), \hat{σ}ₙ² denotes the estimated noise power and α a scaling factor that can be adjusted as a noise margin.

To obtain, \hat{σ}ₙ², noise power estimation can be performed at block 106 by averaging the samples in a “Noise-only” region (outside the low pass filter cut-off region). Assuming all the samples outside the energy concentration region contain noise only, block 106 can be implemented as a low rank noise power estimator that averages the samples located in a “noise only” region, as is given by

$${\hat{σ}}_{n}^{2} = \frac{1}{N - 2 {N}_{c}} {\sum }_{n = {N}_{c}}^{N - {N}_{c} - 1} {\vert {\hat{h}}_{LS} ( n ) \vert}^{2} . \qquad ( 10 )$$

This noise power estimation suffers severe bias at a small RB allocation due to CIR energy leakage. Thus, it results in performance loss due to removal of useful in-band signals.

Accordingly, the final channel estimates in the frequency domain with a low pass filter and in-band noise removal can be updated and obtained by passing the noise-removed samples to a DFT block as follows:

$${\hat{H}}_{LPFNR} ( k ) = {\sum }_{n = 1}^{N - 1} {w}_{LPFNR} ( n ) {\hat{h}}_{LS} ( n ) {e}^{- j 2 π \frac{nk}{N}} , k ∈ S \qquad ( 11 )$$

As is shown, the above DFT-based CE method does not require any information about channels. Further, DFT/IDFT are available blocks in the system. Thus, it has very low complexity.

The conventional method described above with respect to FIG. 1 addresses noise interference by applying a low pass filter with CP length (or channel length) for cut-off frequency determination and an in-band noise suppression. This method is effective when all sub-carriers (after interpolation) in an OFDM symbol are assigned for channel estimation since there is no need for zero-padding extension and the channel taps with detectable energy usually falls into the CP region.

However, for SC-FDMA in an LTE uplink with a large number of users, the reference signals are transmitted in a localized chunk consisting of a relatively small number of RBs. In this scenario, the method suffers significant performance loss due to CIR energy leakage.

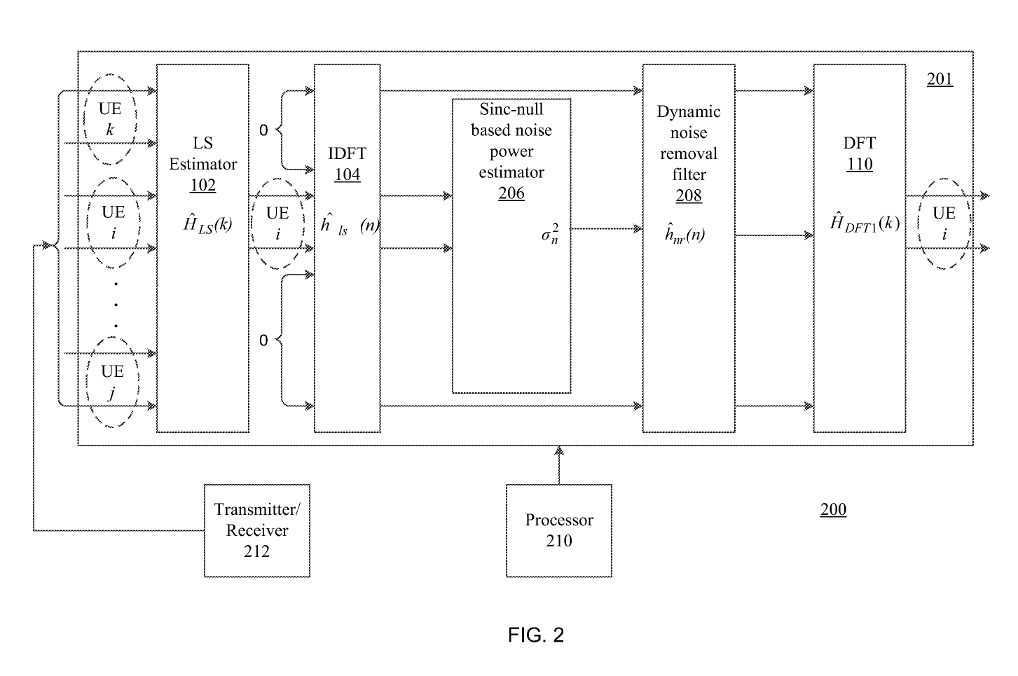

Turning now to FIGS. 2-5, various exemplary embodiments of channel estimation systems and methods are illustratively depicted. It should be noted that each of the systems and methods depicted in FIGS. 2-5 can be implemented in either a UE or an eNodeB/base station. For example, each of the systems can include a transmitter and/or receiver 212. In embodiments in which the channel estimation systems and methods are implemented in a UE, the UE can transmit pilot signals with element 212 to the eNodeB/base station. In turn, the eNodeB/base station can obtain channel samples from the pilot signals to compile, for example, samples C(k) and transmit indications of C(k) to the UE to permit the UE to determine the channel estimates in accordance with the methods and systems described herein below. The UE can employ the channel estimates to, for example, implement link adaptation for the transmission of data to the eNodeB/base station on the uplink. Alternatively, if the eNodeB/base station implements the methods/systems of FIGS. 2-5 described herein below, then the element 212 can be employed to receive the pilot signals from the UEs and the eNodeB/base station can implement the channel estimation systems/methods directly. The eNodeB/base station can employ the obtained channel estimates to perform coherent demodulation of data signals transmitted by the UEs. Alternatively, the eNodeB/base station can transmit indications of the channel estimates to the UE to enable the UE to perform link adaptation, as noted above. Similarly, the UE can determine and transmit channel estimates to the eNodeB/base station to enable the eNodeB/base station to perform coherent demodulation, as noted above. Further, not all portions of the systems/methods of FIGS. 2-5 need to be performed in only one of the UEs and the eNodeB/base station. For example, portions of systems/methods of FIGS. 2-5 can be implemented in the UE and the remaining portions of the systems/methods can be implemented in a eNodeB/base station, where the UEs and eNodeB/base station can communicate any parameters determined therein to enable the system to obtain the channel estimates. Moreover, it should also be noted that the systems/methods of FIGS. 2-5 can be implemented on the down link, where the eNodeB/base station transmits pilot signals and the UE receives the pilot signals. Here, the systems/methods of FIGS. 2-5 can otherwise be implemented in a similar manner with the same alternatives described above.

In addition, it should be understood that one or more of the block components illustrated in the FIGS. 2-5 can be implemented by or controlled by one or more hardware processors 210. For example, each of the blocks designated within blocks 201, 301 and 401 for FIGS. 2, 3 and 4, respectively, can be implemented in hardware or hardware and software with software instructions stored on a storage medium, as noted above.

With reference now in particular to FIG. 2, a block/flow diagram of a DFT-based CE system/method 200 including enhancements in accordance with the present principles in the transform or time domain is illustratively depicted. The enhancements include a sinc-null based noise power estimation in block 206 and noise removal based on windowing in block 208. Blocks 102, 104 and 110 can be implemented as discussed above. However, here, a sinc-null noise power estimator 206 is employed to estimate the noise power level in the time domain, followed by a dynamic noise removal based on windowing in block 208 that is configured to suppress the time domain noise.

It is noted that, preferably, each UE will perform the DFT-based CE method 200 (or methods 300, 400 or 500 described herein below) independently. Without loss of generality, we assume the first M=12*n_{RB} tones are allocated to a current UE of interest, where n_{RB} is the number of allocated RBs with 12 sub-carriers per RB. Note that the zero-padding in (4) imposes a rectangular windowing W_{f} in the frequency domain, i.e.,

$${W}_{f} = \{ \begin{matrix}1 , & 0 \leq k \leq M - 1 , \\ 0 , & otherwise .\end{matrix} \qquad ( 12 )$$

Thus, the resulted transform/time domain channel estimates ĥ_{LS}(n) are the convolutional output of the raw LS channel estimates h_{LS} (n) and spectral response of W_{f} plus colored noise, i.e.,

\tilde{h}_{LS}(n)=h_{LS}(n) [symbol] g_{w}+ε(n), 0≦n≦N−1 (13)

where g_{w} is the spectral response of W_{f} and ε(n) the residual noise in the LS results. [symbol] denotes cyclic convolution.

For any UE with a given RB assignment, g_{w} is a known sinc function having all the nulls occurring at every Δn samples with the sinc null set given by

$${Ω}_{0} ( i ) = i * Δ n , i = 1 , 2 , … , ⌊ \frac{N}{Δ n} ⌋ \qquad ( 14 )$$

where

$$Δ n {=}^{Δ} ⌊ \frac{N}{12 * {n}_{RB}} ⌋$$

and └*┐ is a floor function giving the largest integer smaller than the argument.

For small RB allocations, CFR associated with assigned RB(s) is relatively flat so null points of convolutional time domain samples are approximately those of the known sinc function. Using this fact, we can improve the noise power estimation by averaging the samples in the vicinity of the sinc nulls (hence, the name sinc null method). Thus, the noise power estimation can be improved and implemented at block 206 as

$${σ}_{n 1}^{2} = \frac{{\sum }_{n = 0}^{N - 1} {w}_{noise} ( n ) {\vert {h}_{LS} ( n ) \vert}^{2}}{{\sum }_{n = 0}^{N - 1} {w}_{noise} ( n )} , 0 \leq n < N , \qquad ( 15 )$$

where wₙₒᵢₛₑ and the samples collected for the estimated noise power is given by

$${w}_{noise} ( n ) = \{ \begin{matrix}1 , & {Ω}_{0} ( i ) - ⌊ \frac{Δ n}{β} ⌋ \leq n \leq {Ω}_{0} ( i ) + ⌊ \frac{Δ n}{β} ⌋ , \\ 0 , & otherwise\end{matrix} \\ i = 1 , 2 , … , ⌊ \frac{N}{Δ n} ⌋ \qquad ( 16 )$$

β is a factor determining the number of samples to be collected near each sinc null point for noise estimation. In our simulations, β=8 is chosen with a best performance and complexity tradeoff. However, β=8 can be preferably chosen as an integer ranging from (inclusive) 4 to 12 depending on implementation complexity and performance specifications. For a certain range of β, a smaller β renders more samples for the noise estimation (with higher complexity) and thus provides better performance. But if β is too small, it degrades the performance due to CIR energy leakage.

With the estimated noise power, the system/method at block 208 can now eliminate the noise in the time domain by applying a dynamic noise removal or filter windowing (instead of a hard boundary low pass filter) based on

$${w}_{NR 1} ( n ) = \{ \begin{matrix}1 , & {\vert {h}_{LS} ( n ) \vert}^{2} \geq α {\hat{σ}}_{n 1}^{2} \\ 0 , & {\vert {h}_{LS} ( n ) \vert}^{2} < α {\hat{σ}}_{n 1}^{2} ,\end{matrix} \\ 0 \leq n \leq N - 1 \qquad ( 17 )$$

After suppressing the insignificant channel coefficients, the noise-removed channel coefficients are converted at block 110 into frequency domain channel estimates given by

$${\hat{H}}_{DFT 1} ( k ) = {\sum }_{n = 1}^{N - 1} {w}_{NR 1} ( n ) {\hat{h}}_{LS} ( n ) {e}^{- j 2 π \frac{nk}{N}} , k ∈ S . \qquad ( 18 )$$

Note that other windowing functions such as Hanning (raised-cosine) or Bessel window can be used to extend the frequency domain estimates in (4). A different level of spectral leakage effect will be observed and the nulls of the resulted spectrum response of the windowing function can be similarly utilized to improve the noise power estimation.

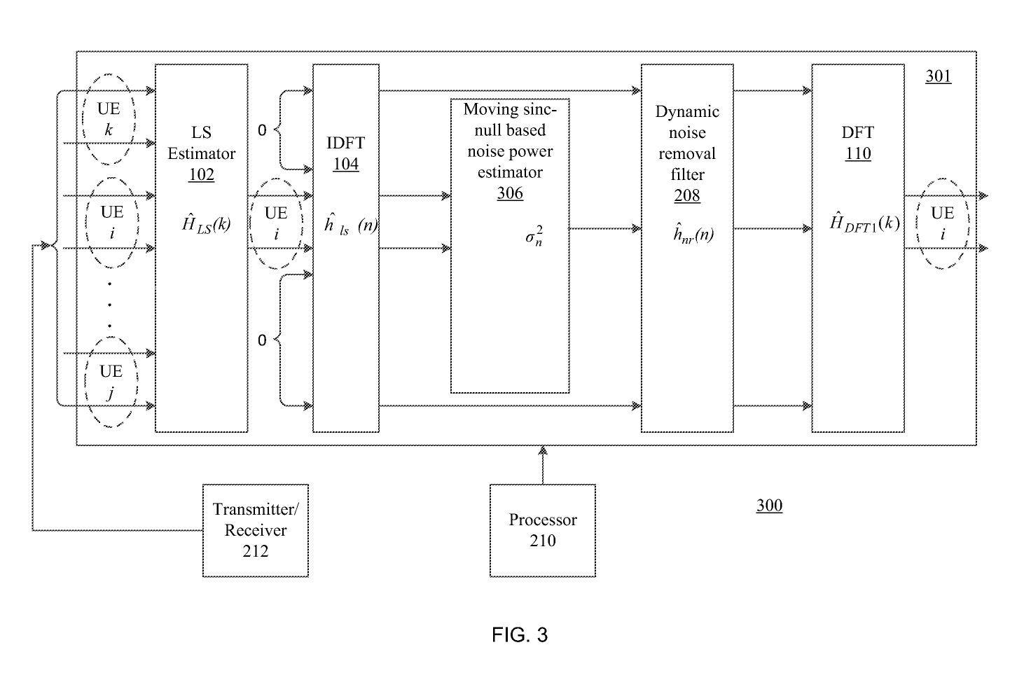

Referring now to FIG. 3, with continuing reference to FIG. 2, an enhanced channel estimation system/method 300 that accounts for timing offsets is illustratively depicted. In the above-described sinc-null based noise power estimation system/method 200, it was assumed that there was perfect timing synchronization in the LTE uplink. However, it is quite common that there exists a certain timing offset in a practical LTE system. For example, one or more UEs and one or more eNodeB's or base stations can have respective time references that are not synchronized or are offset. In the system/method 300, the blocks 102, 104 and 110 can be implemented as described above. Here, the system/method 300 can address a timing offset by employing a moving window sinc-null based power estimator block 306.

For example, a timing offset in the time domain introduces a phase ramp effect over the tones or, equivalently, frequency selectivity in the transform domain. Assuming there is a θ-sample offset, we have the phase rotated LS estimates over the allocated RB given by

$${\tilde{H}}_{LS} ( k ) = {e}^{\frac{- j 2 π k θ}{N}} {\hat{H}}_{LS} ( k ) . \qquad ( 19 )$$

The phase ramp can be absorbed in the RB allocation window function so that its corresponding time domain signal is a shifted sinc function. For low RB allocation, we can use the null points of this shifted sinc function for noise power estimation. However, since the shift is not known, block 306 uses a moving window technique to determine a good set of null points for noise power estimation.

Assuming P is the total number of moving windows being accumulated

$$P = \frac{( N - 2 * {N}_{c} )}{Δ n}$$

and the size of each moving window

$$D = \frac{2 Δ n}{β} ,$$

the accumulated energy from all moving windows at a O-sample offset can be calculated by the block 306 as

$${σ}_{n}^{2} ( θ ) = {\sum }_{p = 0}^{P - 1} {\sum }_{d = 0}^{D - 1} {\vert {\hat{h}}_{LS} ( {N}_{c} + p * Δ n + d + θ ) \vert}^{2} , \\ 1 \leq θ \leq Δ n \qquad ( 20 )$$

Note that the collected samples are within a region of [N_{c}+1:N−N_{c}] and all windows share a same timing offset. Thus, block 306 can find the detected offset as

$${θ}^{*} = arg {min}_{1 \leq θ \leq Δ n} {σ}_{n}^{2} ( θ ) \qquad ( 21 )$$

Accordingly, block 306 can determine the updated noise power that is estimated with a robustness to a timing offset as

$${\hat{σ}}_{n 2}^{2} = \frac{{σ}_{n}^{2} ( {θ}^{*} )}{P * D} . \qquad ( 22 )$$

After the updated estimated noise power is determined from (22), the noise filter 208 can implement noise filtering similar to (17) by applying

$${w}_{NR 2} ( n ) = \{ \begin{matrix}1 , & {\vert {h}_{LS} ( n ) \vert}^{2} \geq α {\hat{σ}}_{n 2}^{2} \\ 0 , & {\vert {h}_{LS} ( n ) \vert}^{2} < α {\hat{σ}}_{n 2}^{2} ,\end{matrix} \\ 0 \leq n \leq N - 1 \qquad ( 23 )$$

Finally, the channel estimates for a current DMRS signal can be obtained by an IDFT operation as given in (18) in block 110. In practical LTE systems, the channel estimates from the two DMRS signals in each TTI will be combined (such as using equal gain combining) to obtain the final channel state information for coherent demodulation and link adaptation.

It should be noted that the method 300 can be performed in scenarios in which timing in the system is synchronized as well as situations in which a timing offset exists. Indeed, the method 300 performs well in systems with or without a timing offset, as the system without a timing offset is a special case in which the timing offset is zero. However, implementation of the method 300 increases the computational complexity as compared to the method 200. Thus, in applications in which computational complexity is a concern, for example, in devices in which computational resources are relatively scarce, certain exemplary embodiments can be configured to determine whether a timing offset exists and can apply the appropriate method to minimize the use of computation resources.

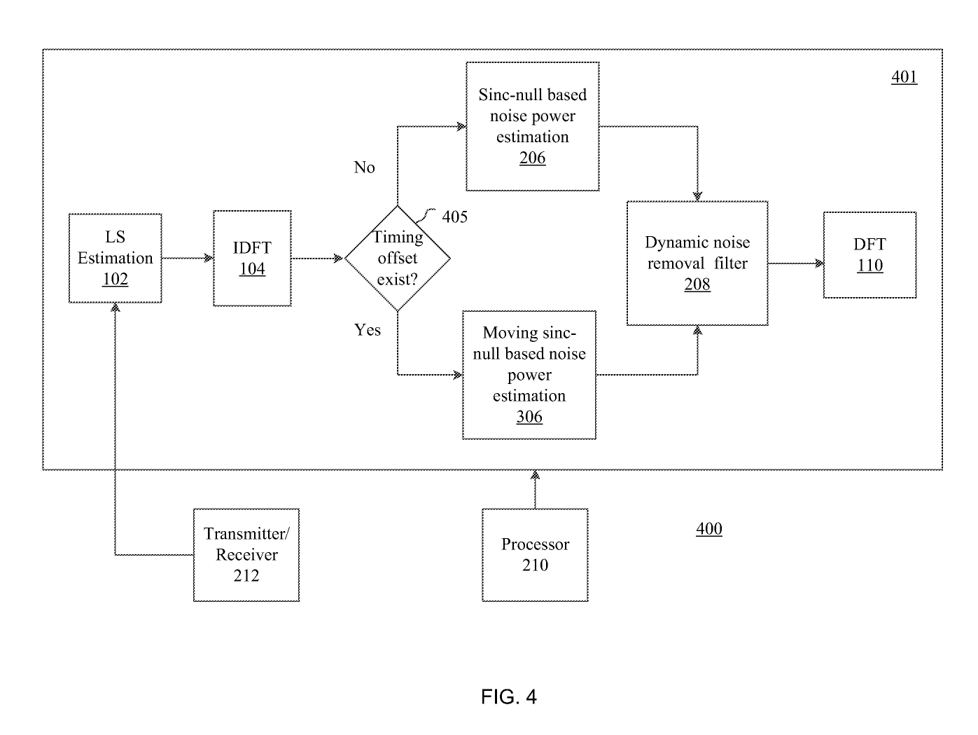

For example, referring now to FIG. 4 with continuing reference to FIGS. 2 and 3, a system/method 400 incorporating elements from both the system/method 200 and system/method 300 is illustratively depicted. Here, the method 400 can be employed in, for example, devices or systems in which computational complexity is a concern. In particular, the system/method 400 can include a determination block 405, at which it is determined whether a timing offset exists in the system. For example, as noted above, one or more UEs and one or more eNodeB's or base stations can have respective time references that are not synchronized or are offset. Here, blocks 102 and 104 can be implemented as discussed above. At block 405, if the system/method 400 detects that a timing offset exists or is likely to exist, then the system/method 400 can estimate the noise power in accordance with block 306, as discussed above with respect to FIG. 3. Otherwise, if the system/method 400 detects that timing is synchronized on the communication link, then the system/method 400 can estimate the noise power in accordance with block 206, as discussed above with respect to FIG. 2. Here, the implementation of block 206 can be made to, for example, minimize use of computational resources. Thereafter, the system/method 400 can implement the noise filter block 208 and the DFT block 110 to obtain the channel estimates in the frequency domain, as discussed above.

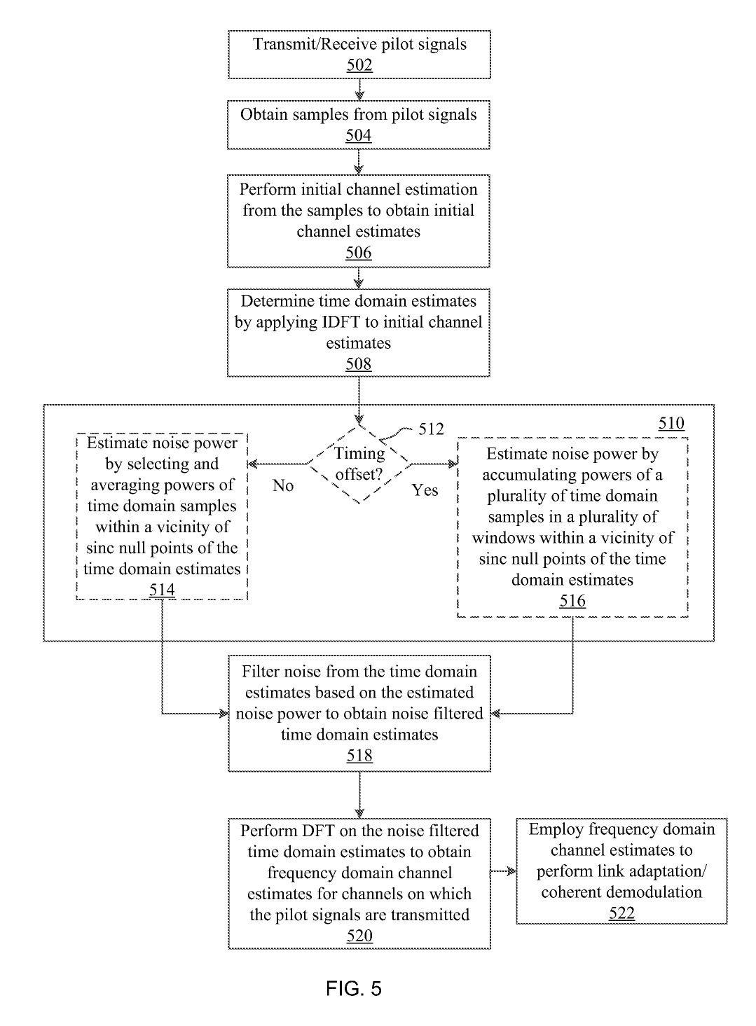

Referring now to FIG. 5, an exemplary method for determining and employing channel estimates in accordance with an embodiment of the present principles is illustratively depicted. It should be noted that any of the features discussed above with respect to FIGS. 2-4 can be implemented within the method 500. In addition, as indicated above, the method 500 can be implemented by a UE, an eNodeB/base station or by a combination of a UE and an eNodeB/base station.

The method 500 can begin at step 502, at which the transmitter/receiver 212 can transmit or receive pilot signals. For example, as noted above, a UE can transmit pilot signals to an eNodeB/base station on an uplink or the eNodeB/base station can receive pilot signals transmitted by the UEs.

At step 504, the transmitter/receiver 212 can obtain samples from the pilot signals. For example, an eNodeB/base station can obtain samples from received pilot signals and provide the samples to an LS estimator 102 implemented therein. Alternatively, a UE can receive feedback from the eNodeB/base station indicating samples obtained from its pilot signals to permit the UE to perform channel estimation.

At step 506, the LS estimator 102 can perform an initial channel estimation from the samples to obtain initial channel estimates. For example, as discussed above with respect to FIG. 1, the LS estimator 102 can apply (3) to obtain \tilde{H}_{LS}(k).

At step 508, the IDFT module 104 can determine time domain estimates by applying an inverse discrete Fourier transform to the initial channel estimates computed from pilot signals. For example, as noted above with respect to FIG. 1, the IDFT 104 can pad the unallocated tones with zeros and can apply (5) to determine ĥ_{LS}(n).

At step 510, the processor 210 can determine and utilize time domain samples that are within a vicinity of sine null points of the time domain estimates. For example, as discussed above with respect to block 405, the processor 210 can determine at step 512 whether a timing offset exists. For example, if the processor 210 determines that a timing offset exists on the communication link on which the pilot signals are transmitted, then the method can proceed to step 516 at which the noise power estimator 306 can determine \hat{σ}ₙ₂² by accumulating powers of a plurality of time domain samples in a plurality of windows that are within a vicinity of sinc null points of the time domain estimates, as discussed above. Otherwise, if the processor 210 determines that timing is synchronized on the communication link on which the pilot signals are transmitted, then the method can proceed to step 514, at which the noise power estimator 206 can determine \hat{σ}ₙ₁² by selecting and averaging powers of time domain samples that are within a vicinity of sinc null points of the time domain estimates, as discussed above. It should be noted that the decision step 512 need not be implemented. For example, in accordance with other implementations of the method, the method 500 can perform noise power estimation in accordance with step 514 only or in accordance with step 516 only. Step 512 can be implemented for systems or devices in which computational complexity is a concern to, for example, conserve the use of computational resources.

The method can proceed to step 518, at which the dynamic noise removal filter 208 can filter noise from the time domain estimates based on the estimated noise power to obtain noise filtered time domain estimates. Here, the filtering can be based on dynamic windowing over the time domain estimates determined by applying the inverse Fourier transform. For example, as discussed above, block 208 can determine w_{NR1}(n) or w_{NR2}(n) based on \hat{σ}ₙ₁² or \hat{σ}ₙ₂², respectively.

At step 520, the DFT module 110 can perform a discrete Fourier transform on the noise filtered time domain estimates to obtain frequency domain channel estimates for channels on which the pilot signals are transmitted. For example, the DFT module can apply (18) to determine Ĥ_{DFT1}(k), as discussed above.

At step 522, the processor 210 can employ the frequency domain channel estimates to perform link adaption or coherent demodulation. For example, if an eNodeB/base station implements the method 500, the eNodeB/base station can employ the channel estimates to perform coherent demodulation on data signals received from UEs, as discussed above. Alternatively, for example, if a UE implements the method 500, the UE can employ the channel estimates to perform link adaption on data signals transmitted to the eNodeB/base station, as discussed above.

It should be noted that the methods and systems described herein have substantial benefits and advantages over known systems. For example, the DFT-based channel estimation systems and methods have a relatively low complexity and have better noise suppression than conventional DFT-based systems, thus better mean square error performance. This noise suppression can be achieved without the cost of removing useful CIR. Further, as noted above, the sinc-null based noise power estimation is immune to CR energy leakage for small RB assignments. In addition, as also noted above, the sinc-null based noise power estimation that employs moving windows is robust to timing offsets.

Having described preferred embodiments of methods and systems for DFT-based channel estimation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for performing channel estimation comprising:
determining time domain estimates by applying an inverse discrete Fourier transform to initial channel estimates computed from pilot signals;
estimating, by a processor, noise power by selecting and averaging powers of time domain samples that are within a vicinity of sinc null points of the time domain estimates;
filtering noise from the time domain estimates based on the estimated noise power to obtain noise filtered time domain estimates; and
performing a discrete Fourier transform on the noise filtered time domain estimates to obtain frequency domain channel estimates for channels on which said pilot signals are transmitted.

2. The method of claim 1, wherein said filtering is based on dynamic windowing over the time domain estimates determined by applying the inverse discrete Fourier transform.

3. The method of claim 1, wherein the estimating the noise power is performed in response to determining that timing is synchronized on a communication link on which said pilot signals are transmitted.

4. A method for performing channel estimation comprising:
determining time domain estimates by applying an inverse discrete Fourier transform to initial channel estimates computed from pilot signals;
estimating, by a processor, noise power by accumulating powers of a plurality of time domain samples in a plurality of windows that are within a vicinity of sinc null points of the time domain estimates;
filtering noise from the time domain estimates based on the estimated noise power to obtain noise filtered time domain estimates; and
performing a discrete Fourier transform on the noise filtered time domain estimates to obtain frequency domain channel estimates for channels on which said pilot signals are transmitted.

5. The method of claim 4, wherein said filtering is based on dynamic windowing over the time domain estimates determined by applying the inverse discrete Fourier transform.

6. The method of claim 4, wherein the estimating the noise power is performed in response to determining that a timing offset exists on a communication link on which said pilot signals are transmitted.

7. A system for performing channel estimation comprising:
an inverse discrete Fourier transform module configured to determine time domain estimates by applying an inverse discrete Fourier transform to initial channel estimates computed from pilot signals;
a noise power estimator, implemented by a processor, configured to estimate noise power by determining and utilizing time domain samples that are within a vicinity of sinc null points of the time domain estimates;
a noise filter configured to filter noise from the time domain estimates based on the estimated noise power to obtain noise filtered time domain estimates; and
a discrete Fourier transform module configured to perform a discrete Fourier transform on the noise filtered time domain estimates to obtain frequency domain channel estimates for channels on which said pilot signals are transmitted.

8. The system of claim 7, wherein said noise filter is further configured to perform dynamic windowing over the time domain estimates determined by applying the inverse discrete Fourier transform.

9. The system of claim 7, wherein the noise power estimator is further configured estimate the noise power by selecting and averaging powers of the time domain samples that are within a vicinity of sinc null points of the time domain estimates in response to determining that timing is synchronized on a communication link on which said pilot signals are transmitted.

10. The system of claim 7, wherein the noise power estimator is further configured estimate the noise power by accumulating powers of the time domain samples, wherein the time domain samples are in a plurality of windows that are within the vicinity of the sinc null points of the time domain estimates.
